(19) United States
(12) Patent Application Publication
(10) Pub. No.: US 2005/0056436 A1
(43) Pub. Date: Mar. 17, 2005

(54) Golfroller II in I

(76) Inventor: Erik R. Lundh, Ft. Lauderdale, FL (US)

Correspondence Address: ERIK R. LUNDH, #407, 9230B LAGOON PLACE, FT. LAUDERDALE, FL, 33324, US

(21) Appl. No.: 10/452,468

(22) Filed: Sep. 12, 2003

(51) Int. Cl. A01B 1/00

(52) U.S. Cl. 172/371

(57) ABSTRACT

A golf course sand smoothing and ball retrieving apparatus includes a cylinder having two spaced apart cylinder end portions interconnected by an interconnection structure including several longitudinally extending interconnection members spaced apart from each other to define a circumferential series of cylinder open spaces, the cylinder being rotatably mounted on cylinder a cylinder axle structure connected to a telescoping apparatus handle. The cylinder axle structure preferably extends out of each cylinder end portion, and is connected to an axle mounting structure and the axle mounting structure is connected to the apparatus handle. Methods of apparatus use are also provided.

### BACKGROUND OF THE INVENTION

1. Field of the Invention

The present invention relates generally to the field of sports equipment and particularly to sports equipment used in the game of golf. More specifically the present invention relates to a golf course sand smoothing and ball retrieving apparatus in the form of a cylinder having two spaced apart cylinder end portions interconnected by an interconnection structure including a plurality of longitudinally extending interconnection members spaced apart from each other to penetrate and redistribute sand to be smoothed to remove footprints and to define a circumferential series of cylinder open spaces into one of which a ball seats and is retained during ball retrieval, the cylinder being rotatably mounted on a cylinder axle extending longitudinally through the cylinder and out of each cylinder end portion, the cylinder axle being connected to an axle mounting structure, the further including an elongate apparatus handle extending from the axle mounting structure. The apparatus handle preferably is formed of telescoping segments to retract into a compact carrying mode and to extend to a user standing position reach mode. Methods of apparatus use are also provided.

2. Description of the Prior Art

There have long been rakes for smoothing sand at golf course sand traps. One problem with these rakes has been the unwieldy length of the rake handle, making carrying of a rake on a golf course inconvenient. Another problem has been the limitation that the rake can be moved over sand and can smooth sand only when dragged in one direction. Then the rake must be lifted and moved back to its general starting point, the lifting and retrieving steps requiring time and user energy but providing no smoothing of the sand. Yet another problem is that a rake is not well suited to golf ball retrieval because in soft sand the rake tends to drive the ball into the ground and slide over and off the ball.

It is thus an object of the present invention to provide a golf course sand smoothing and ball retrieving apparatus having an apparatus handle and an apparatus cylinder rotatably connected to the handle which smooths sand in movements both toward and away from the user and without need to lift the cylinder.

It is another object of the present invention to provide such an apparatus which retracts into a compact carrying mode for convenient carrying by a golf player.

It is still another object of the present invention to provide a method and such an apparatus for performing a method of engaging and retrieving golf balls without pressing the ball into the sand.

It is finally an object of the present invention to provide such an apparatus which is simple in design, durable, easy to use, and inexpensive to manufacture.

### SUMMARY OF THE INVENTION

The present invention accomplishes the above-stated objectives, as well as others, as may be determined by a fair reading and interpretation of the entire specification.

A golf course sand smoothing and ball retrieving apparatus is provided including a cylinder having two spaced apart cylinder end portions interconnected by an interconnection structure including several longitudinally extending interconnection members spaced apart from each other to define a circumferential series of cylinder open spaces, the cylinder being rotatably mounted on cylinder a cylinder axle structure connected to an apparatus handle.

The cylinder axle structure preferably extends out of each cylinder end portion, and is connected to an axle mounting structure and the axle mounting structure is connected to the apparatus handle. The interconnection members preferably are elongate rods having rod ends connected to the cylinder end portions. The apparatus handle preferably includes several handle telescoping segments, so that the apparatus handle is retractable into a compact carrying mode and is extendable into a ball and sand reaching mode. The axle structure preferably includes an elongate rod and the axle mounting structure preferably includes two axle rod extension segments extending from the axle and converging toward and connected to the apparatus handle.

A method of smoothing golf course sand using the apparatus includes the steps of: grasping the apparatus handle; and pushing and pulling the cylinder over an area of sand to be smoothed such that the cylinder rolls over the sand and revolves around the cylinder axle means. A method of retrieving a golf ball using the apparatus includes the steps of: grasping the apparatus handle; positioning the cylinder on the far side of the ball relative to the user; and pulling the cylinder toward the user along the ground so that the cylinder abuts the ball and the ball seats in a cylinder space between elongate interconnection members while the ball slides over the ground such that the ball is retained by the cylinder while the cylinder is pulled toward the user.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a side view of the preferred embodiment of the golf course sand smoothing and ball retrieving apparatus and a golf ball, shown with the telescoping handle retracted into its compact carrying mode but shown otherwise positioned for retrieval of the golf ball.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

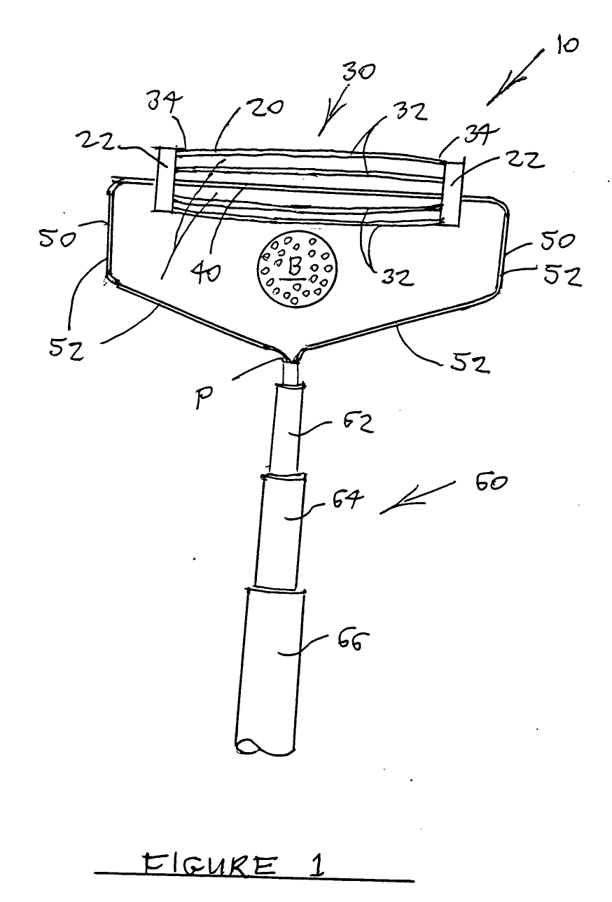

Referring to FIG. 1, a golf course sand smoothing and ball retrieving apparatus 10 is disclosed. Apparatus 10 includes a cylinder 20 having two spaced apart cylinder end portions 22 interconnected by an open interconnection structure 30 including a plurality of longitudinally extending interconnection members 32 spaced apart circumferentially from each other to define a circumferential series of cylinder open spaces 36, the cylinder 20 being rotatably mounted on a cylinder axle 40 extending longitudinally through the cylinder 20 and out of each cylinder end portion 22, the cylinder axle 40 being connected to an axle mounting structure 50, the axle mounting structure 50 in turn being connected to an elongate apparatus handle 60. The interconnection members 32 preferably are elongate rods 32 having rod ends 34, and the cylinder end portions 22 preferably are disks to which the elongate rod ends 34 are connected. The apparatus handle 60 preferably is formed of handle telescoping segments 62, 64 and 66 to retract into a compact carrying mode and to extend to a ball and sand reaching mode. The cylinder axle 40 preferably is an elongate rod 40 and the axle mounting structure 50 preferably includes two axle rod extension segments 52 angled from the cylinder axle 40 toward a common point of extension segment convergence P, extending from the cylinder axle 40 to the handle 60.

### Method

In practicing the invention, the following method may be used to smooth golf course sand, a method is provided in which the user grasps the handle 60 and pushes and pulls the cylinder 20 over an area of sand to be smoothed so that the cylinder 20 rolls over the sand and revolves around the cylinder axle 40. The elongate interconnection members 22 ride sequentially into and out of the surface of the sand and thereby smooth the sand. To retrieve a golf ball B, a method is provided in which the user once again grasps the handle 60 and positions the cylinder 20 on the far side of the ball relative to the user and then pulls the cylinder 20 toward the user along the ground so that the cylinder 20 abuts the ball B and the ball B seats in a cylinder space 36 between elongate interconnection members 32, but does not fully enter the cylinder 20, while the ball B slides over the ground so that the ball B is retained by the cylinder 20 while the cylinder 20 is pulled toward the user.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A golf course sand smoothing and ball retrieving apparatus, comprising:
a cylinder having two spaced apart cylinder end portions interconnected by an interconnection structure including a plurality of longitudinally extending interconnection members spaced apart from each other to define a circumferential series of cylinder open spaces, said cylinder being rotatably mounted on cylinder axle means connected to an apparatus handle.

2. The apparatus of claim 1, wherein said a cylinder axle extends out of each said cylinder end portion, and is connected to an axle mounting structure and said axle mounting structure beings connected to said apparatus handle.

3. The apparatus of claim 1, wherein said interconnection members are elongate rods having rod ends connected to said cylinder end portions.

4. The apparatus of claim 1, wherein said apparatus handle comprises a plurality of handle telescoping segments, such that said apparatus handle is retractable into a compact carrying mode and is extendable into a ball and sand reaching mode.

5. The apparatus of claim 1, wherein said axle comprises an elongate rod and wherein said axle mounting structure comprises two axle rod extension segments extending from said axle and converging toward and connected to said apparatus handle.

6. A method of smoothing golf course sand using an apparatus comprising a cylinder having two spaced apart cylinder end portions interconnected by an interconnection structure including a plurality of longitudinally extending interconnection members spaced apart from each other to define a circumferential series of cylinder open spaces, said cylinder being rotatably mounted on cylinder axle means connected to an apparatus handle, comprising the steps of:
grasping the apparatus handle;
and pushing and pulling the cylinder over an area of sand to be smoothed such that the cylinder rolls over the sand and revolves around the cylinder axle means.

7. A method of retrieving a golf ball, using an apparatus comprising a cylinder having two spaced apart cylinder end portions interconnected by an interconnection structure including a plurality of longitudinally extending interconnection members spaced apart from each other to define a circumferential series of cylinder open spaces, said cylinder being rotatably mounted on cylinder axle means connected to an apparatus handle, comprising the steps of:
grasping the apparatus handle;
positioning the cylinder on the far side of the ball relative to the user;
and pulling the cylinder toward the user along the ground so that the cylinder abuts the ball and the ball seats in a cylinder space between elongate interconnection members while the ball slides over the ground such that the ball is retained by the cylinder while the cylinder is pulled toward the user.
